(19) United States
(12) Patent Application Publication
(10) Pub. No.: US 2008/0015878 A1
(43) Pub. Date: Jan. 17, 2008

(54) Real-time user profile platform for targeted online advertisement and personalization

(75) Inventors: Andrew An Feng, Cupertino, CA (US); Nilesh Ramniklal Gohel, Fremont, CA (US)

Correspondence Address: DREIER LLP, 499 PARK AVE, NEW YORK, NY, 10022, US

(73) Assignee: Yahoo! Inc.

(21) Appl. No.: 11/488,933

(22) Filed: Jul. 17, 2006

(51) Int. Cl. G06Q 10/00; G06Q 30/00

(52) U.S. Cl. 705/1

(57) ABSTRACT

A method stores a universal user profile for a user across multiple web applications, updates the universal user profile based on up-to-the-second user activity, and retrieves the updated user profile in real-time for a requesting web application. The method enables providing targeted content to a user based on the up-to-the-second user preferences and user activity. The method enables data cleanup and notification, based on an occurrence of specific user activities, an update of a user profile, a data policy, or passage of time. A notification may result in sending of marketing information to the user or updating the user's profile, or may result in further updating of user's profile.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### REFERENCE TO EARLIER-FILED APPLICATIONS

This application hereby incorporates by reference U.S. application Ser. No. ______ filed on Dec. 9, 2004 entitled “Personalized Web Applications Based on Anticipation of User's Interests.”

### TECHNICAL FIELD

The invention relates generally to the field of web applications, and more particularly to systems and methods for maintaining universal user profiles based on current user activity.

### BACKGROUND

Online service providers provide users with many different services such as email, instant messaging (IM), shopping services, dating and personals services, search engines, directories and guides, audio and video browsing services, fantasy sports, games, and the like. Many of these services require a user to register for a service, such as in the case of an e-mail service, by creating a user account including a user ID and a password. Other services may require a user to complete a user profile that includes additional information relating to the user, such as in the case of a dating and personals service. A service provider may also allow a user to attain various different levels of membership for a service based on, for example, a registration status (e.g., registered vs. unregistered or paid vs. unpaid). Each online service provider may have different requirements for its users. Accordingly, a single user interacting with many online service providers may have various user profiles associated with various user accounts corresponding to different services.

A modern goal of online service providers and Internet advertisers is targeted content, such as advertisements, personalized to the user based on the user's interests. Interest information may be gleaned from a user's various profiles and from a user's activity data. An online service provider may track user activity based on a user's interaction with the online service and may store the user profile and activity data for future use. Data warehousing technologies and data mining technologies have been used by online service providers to analyze user activity data and update user profile accordingly. To process the massive amount of activity data, these technologies require days to process. This latency may render the profile data, activity data, and interest information less effective for targeting purposes. User's current interest could be quite different from his/her interest of days ago.

### SUMMARY

Embodiments of the present invention provide systems and methods for providing a unified platform for storing user profile data and user activity data in order to create a user's universal profile based on up-to-the-second user activities. Embodiments of the present invention provide systems and methods enabling online service providers to access a user's universal profile in order to present targeted personalized content based on up-to-the-second interest information gleaned from the user's universal profile. Embodiments of the present invention also provide systems and methods for taking action on stored user profile data and stored user activity data such as sending a notification, which may result in sending marketing information to a user, where such action may be based on triggering user events, updating a user profile, passage of a set period of time, or other criteria.

In one embodiment, a method comprises receiving a real-time report of a user event corresponding to an interaction with a first web application by a user, storing representative data of the user event in a store to update a user profile, receiving a request for the user profile from a second web application, and retrieving in real-time at least a portion of the user profile from the store. The first web application and the second application may be served by a common service provider, or they may be served by different service providers. The method may further comprise updating the user profile based on the stored representative data. The updating may occur dynamically, and may utilize a shared write cache accessible by both the first web application and the second web application. The retrieving may similarly utilize a shared read cache accessible by both the first web application and the second web application. The method may further comprise providing at least a portion of the user profile to the second web application. The method may further comprise presenting targeted content to the user via the second web application. The targeted content may based on at least a portion of the user profile, and may include targeted advertisements. The method may further comprise detecting that a triggering event has occurred, and performing an action including at least one of deleting at least a portion of the user profile, deleting a stored user event, or sending a notification to a consuming application in real-time with respect to the triggering event. The triggering event may include an occurrence of a specific user event, an updating of a user profile, a data policy, or passage of a set period of time. The consuming application may be a marketing tool, a profile processor, or a data warehouse so that the notification may be a notification to a profile processor to update a user profile, a notification to a marketing tool to send marketing information to a user, or a notification to a data warehouse to update or modify data stored therein.

In another embodiment, a method comprises receiving a report of a user event corresponding to an interaction with a first web application by a user, storing representative data of the user event in a store to update a user profile, receiving a request for the user profile from a targeted content service, retrieving in real-time at least a portion of the user profile from the store, and providing targeted content to the user via a second web application. The first web application and the second application may be served by a common service provider, or they may be served by different service providers. Similarly, the first web application and the targeted content service may be served by a common service provider, or they may be served by different service providers. The method may further comprise updating the user profile based on the stored representative data. The updating may occur in real-time with respect to the receiving of the report of the user event. The updating may include replicating the user profile in real-time. The real-time replicating of user profile updates enable multiple web applications to access the updated and identical user profile, even when applications are served by different service providers. The method may further comprise providing at least a portion of the user profile to the second web application and, based on that, presenting a customized experience to the user via the second web application. The method may further comprise detecting that a triggering event has occurred and performing an action including at least one of deleting at least a portion of the user profile, deleting a stored user event, or sending a notification to a consuming application in real-time with respect to the triggering event. The triggering event may include an occurrence of a specific user event, an updating of a user profile, a data policy, or passage of a set period of time. The consuming application may be a marketing tool, a profile processor, or a data warehouse so that the notification may be a notification to a profile processor to update a user profile, a notification to a marketing tool to send marketing information to a user, or a notification to a data warehouse to update or modify data stored therein.

In another embodiment, a system comprises a plurality of web applications each one being operative to interact with a user and a universal profile and event store operative to store user profiles and user events representing interactions with the web applications by the user. The web applications may be configured to present the user with a customized experience based on at least a portion of the user's profile. The universal profile and event store is configured to conduct data cleanup of the user profiles and user events based on expiration policies. The universal profile and event store may also be configured to send a notification to a consuming application, such as a marketing tool or a profile processor, based on an occurrence of a specific user event, an updating of the user profile, a notification policy, or passage of a set period of time. The user profiles may comprise profile attribute data, and the universal profile and event store may be organized in user spaces and data spaces, where a user space is a collection of users that share at least one characteristic and a data space is a collection of profile attribute data and user event data that share at least one characteristic. Each user space may have an expiration policy and each data space may have an expiration policy and a notification policy. The universal profile and event store may be organized into a data model that includes a data structure for a profile attribute, a data structure for a user event, a data structure for a user comprising links to profile attributes and user events associated with the user, a data structure for a user space comprising a first data policy and links to users sharing at least one characteristic, and a data structure for a data space comprising a second data policy and links to profile attributes and user events sharing at least one characteristic. The universal profile and event store may be configured to conduct data cleanup or notification to a user space by applying the first data policy and to a data space by applying the second data policy. The universal profile and event store may be implemented using persistent files stored on a disk including an object data file storing a user's profile data and event data and index file that provides the location of the user's data and shared memory including a read cache for caching retrieved profile data and a write cache for reported user event data and modified profile data and an object index cache that provides the location of the data in the shared memory as well as on the disk. The universal profile and event store may be configured to utilize the shared memory in order to decrease an amount of disk access. The universal profile and event store may further include a plurality of store server processes and a store notifier and cleaner process. The store server processes may be configured to replicate updates to user profile data to other universal profile and event stores, while the store notifier and cleaner process is configured to periodically conduct data cleanup and notification procedures. The system may further comprise a targeted content service operative to present the user with targeted content, wherein the targeted content is based on at least a portion of the user profile. The targeted content may include advertisements. The system may further comprise a marketing tool operative to present the user with marketing information based on a triggered notification by the universal profile and event store. The system may further comprise a profile processor operative to update a user profile based on a triggered notification by the universal profile and event store.

In another embodiment, a system comprises a means for receiving a report of a user event corresponding to an interaction with a first web application by a user, means for storing representative data of the user event to update a profile, means for receiving a request for a user profile from a second web application, and means for retrieving in real-time at least a portion of the user profile from the store.

In another embodiment, a system comprises a means for receiving a real-time report of a user event corresponding to an interaction with a first web application by a user, means for storing representative data of the user event to update a profile, means for receiving a request for a user profile from a targeted content service, means for retrieving in real-time at least a portion of the user profile from the store, and means for providing targeted content via a second web application based on the at least a portion of the user profile.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A is a block diagram presenting a system for storing, updating, and providing in real-time universal user profiles based on up-to-the-second user activity;

FIG. 1B is a block diagram presenting a system for storing, updating, and providing in real-time universal user profiles based on up-to-the-second user activity between host systems;

FIG. 2 is a block diagram presenting a universal profile and event store;

FIG. 3 is a block diagram presenting a data model for objects within a universal profile and event store;

FIG. 4 is a flow diagram presenting a method for storing user events and updating a user profile based on user events;

FIG. 5 is a flow diagram presenting a method for retrieving a user profile and presenting targeted content based on the user profile;

FIG. 6 is a flow diagram presenting a method for sending a user a notification based on a user triggering event;

FIG. 7 is a flow diagram presenting a method for periodic data cleanup and user notification by the profile and event store.

### DETAILED DESCRIPTION

In the following detailed description, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

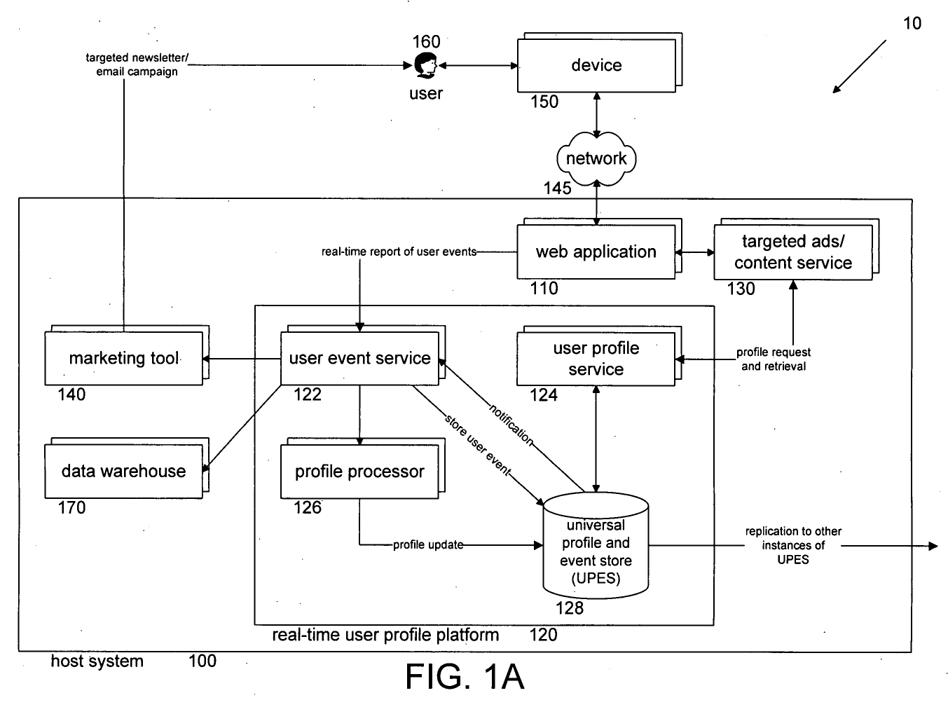

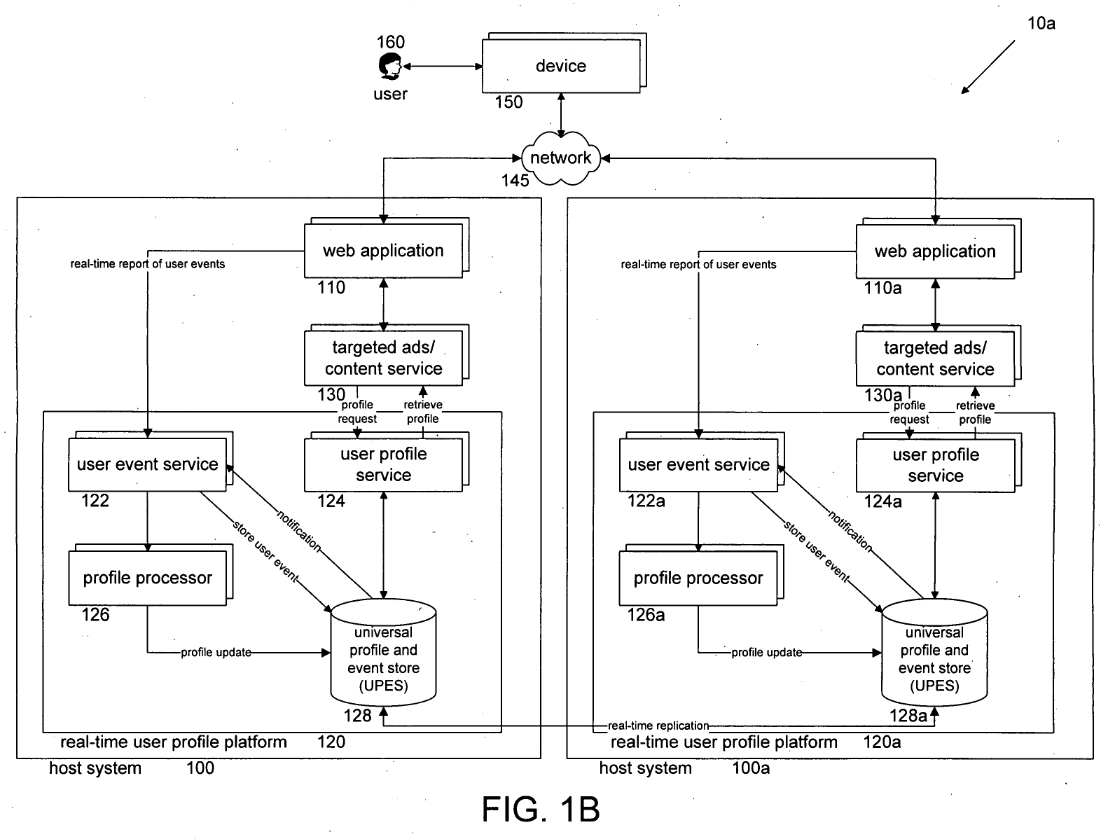

FIG. 1A presents a block diagram illustrating an embodiment of a system 10 for managing universal user profiles for users 160. System 10 includes a plurality of devices 150 coupled via a network 145 (e.g., the WAN commonly referred to as the Internet) to a host system 100. The host system 100 comprises a number of software, hardware, and/or firmware components for storing, updating, and providing in real-time user profiles based on up-to-the-second user activity of a user 160 operating a client device 150.

The host system 100 includes web applications 110 (possibly operated by the same or different service providers), real-time user profile platform (RTUPP) 120, targeted ads/content service (TACS) 130 coupled to web applications 110 and to RTUPP 120, marketing tool 140 coupled to RTUPP 120, and data warehouse 170 coupled to RTUPP 120. RTUPP 120 includes a user event service (UES) 122 coupled to web applications 110, to marketing tool. 140, and to data warehouse 170, a user profile service (UPS) 124 coupled to TACS 130, a profile processor 126 coupled to UES 122, and a universal profile and event store (UPES) 128 coupled to the profile processor 126, to the UES 122, to the UPS 124, and to other instances of UPES 128. Host system 100 may also comprise one or more data stores (not shown) for providing transient and persistent storage of information used in storing, updating, and accessing in real-time a user's universal profile.

A user 160 operating client device 150 interacts with host system 100 via interaction with a web application 110. Client device 150 may be any device that allows for transmission of commands and requests to host system 100. A client device 150 may be a general-purpose computer comprising a processor, transient and persistent storage devices, an input/output subsystem, and a bus to provide a communications path. Client device 150 may have a network interface to the network, such as a wired or wireless Ethernet interface. Client device 150 may run software applications such as a web browsing application, which allows access to web application 110. Example client devices 150 include laptops, PDAs, mobile phones, desktops, etc. Web applications 110 may offer various services including, for example, e-mail, instant messaging (IM), online shopping, dating and personals services, search engines, directories and guides, audio and video services, image hosting, fantasy sports, games, and the like. Each web application 110 may require a user 160 to register for a service, such as in the case of an e-mail service, by creating a user account including e.g., a user ID and a password. Each web application 110 may require a user 160 to complete a user profile that includes personal information relating to the user, such as in the case of a dating and personals service. Each web application 110 may also allow a user 160 to attain various different levels of membership for a service based on, for example, a registration status (e.g., registered vs. unregistered or paid vs. unpaid). Each web application 110 may have different requirements for its users. Accordingly, a single user 160 interacting with many web applications 110 may have various dedicated user profiles associated with various user accounts corresponding to different services of the different web applications 110. Each of the web applications 110 may also be configured to operate with the host system 100 to maintain and exploit universal user profiles. In some embodiments, the universal user profile may replace one or more dedicated user profiles.

As a user interacts with a web application 110, the web application 110 may report user events to UES 122. UES 122 receives reports of user events from the web applications 110, and stores user event information in UPES 128. User events may include interactions such as purchases and other financial transactions, search queries, and file transfers with web applications 110. User events may also include interactions such as registration for a user account, completion of a dedicated or application-specific user profile, or a change in level of membership. UES 122 may alternatively or additionally forward user event information to profile processor 126, which may use the event information to update/modify/reconcile the user's profile information and/or metadata (e.g., indexing) stored in the UPES 128. UES 122 may alternatively or additionally forward user event information to a data warehouse 170, which may further process the user event information.

UPS 124 receives profile requests from TACS 130 and retrieves profile information from UPES 128 in response to the profile requests. Profile information may include information supplied by a user (e.g., personally identifying information) as well as information gleaned from user activity data or user event data. UPS 124 may serve only registered web applications 110, only web applications for a single service provider (e.g., Yahoo! Inc.), only trusted service providers, all service providers, and/or the like. A profile request may include a request for user profile information previously supplied during prior interactions with one or more of the web applications 110, for example, through account registration procedures, transactions, user profile completion procedures, etc. In response to receiving profile information from the UPES 128 in response to the profile request, UPS 124 sends the profile information to TACS 130. In other embodiments, UPS 124 may also send the profile information to web application 110.

TACS 130 uses received profile information to present targeted content to the user 160, e.g., via a banner advertisement on the web application 110. In one embodiment, TACS 130 receives the user profile information from UPS 124 and determines an appropriate (relevant in content, relevant in time, user specific, etc.) targeted content for the user based on the profile information received. For example, a known user 160 may currently interact with a web application 110 such as a music service. In response to a profile request, UPS 124 may retrieve the user's universal profile from UPES 128. The user's universal profile may include information reflecting the user's prior interaction with the music service and may include information reflecting the user's prior interaction with one or more other web applications 110, such as a shopping service. Thus, the user's universal profile may include information indicating that the user prefers classic rock music (e.g., based on the user's prior interactions with the music service, as captured by stored user event information) and information that the user has recently been shopping for a sport utility vehicle (e.g., based on the user's prior interactions with a shopping service and stored user event information). Armed with this information, TACS 130 may present targeted content to the user 160, such as links to play and/or purchase and download classic rock music titles using the music service. TACS 130 may use the information to present the user with targeted content such as an offer to buy tickets to a classic rock music concert. TACS 130 may use the information to present targeted ads related to SUV dealerships, auto financing companies, and auto insurance companies. Other additional or alternative options are also possible. In other embodiments, the web application 110 may also receive the universal profile information from the UPS 124 and use it to assist the user, provide a customized interface, to complete forms, etc.

Profile processor 126 may process user events to generate metadata from each user event to update a user's universal profile stored in the UPES 128. The metadata may include indexing information, organization information, user event interpretation information, statistical analysis information, group classification information, etc. The profile processor 126 may process user events in real-time, or may perform batch processing of multiple user events. The profile processor 126 may operate offline, by retrieving, analyzing and replacing user profile information stored in the UPES 128. Additionally or alternatively, the profile processor 126 may obtain user event information from the UES 122, may conduct its analysis on the received event information, and may update the UPES 128, if necessary and/or accordingly. For example, if the user event indicates a registration event, the profile processor 126 may update a user attribute for “registered user” to “true.”

In addition to storing user profile information (including metadata from profile processor 126), UPES 128 may also examine the stored profile information for specific criteria (e.g., missing information, stale data, redundant data, excessive information, and like user profile concerns). Upon recognizing the specific criteria, the UPES 128 performs a responsive action. For example, the UPES 128 may send a notification to the UES 122, which may send notifications to marketing tool 140 to send marketing information to certain users. As another example, the UPES 128 may delete now-stale data. Other responses are also possible.

Marketing tool 140 sends a user 160 marketing information based on the specific criteria. Marketing information may include, for example, a targeted newsletter or an email campaign. The marketing tool 140 may send the marketing information to the user via an email, post mail, IM, and/or the like. For example, marketing tool 140 may send marketing information based on a user's registration status, a change in a user's registration status, or a lapse in user activity for a pre-determined amount of time, e.g., 30 days, etc. For example, a user 160 may interact with a web application 110 such as a dating and personals service. The user 160 may change status from that of an unregistered member to that of a registered member. The web application 110 reports this user event to UES 122. UES 122 sends this user event information to UPES 128. UPES 128 may send a notification to UES 122, which forwards the notification and user information to the marketing tool 140 that the user 160 has changed registration status. Based on the change in registration status, marketing tool 140 may send the user marketing information, such as an e-mail containing a membership subscription offer for an upgraded membership. Similarly, if a user 160 does not interact with web application 110 for a pre-determined amount of time, e.g., 30 days, the UPES 128 may send a notification to the UES 122, which informs the marketing tools 140, which may send the user 160 marketing information such as an e-mail containing an offer intended to motivate the user 160 to return to the service.

Data warehouse 170 receives user event information from UES 122. Data warehouse 170 may further process the user event information and may also store and archive user event information. Data warehouse 170 receives notifications from UES 122 in order to update or modify stored data. Notifications may be based on, for example, a notification policy or an expiration policy.

FIG. 1B presents a block diagram illustrating an embodiment of a system 10a for storing, updating, and providing in real-time universal user profiles based on up-to-the-second user activity between host systems. System 10a includes a plurality of devices 150 coupled via a network 145 (e.g., the WAN commonly referred to as the Internet) to host systems 100 and 100a. The host systems 100 and 100a each comprise a number of software, hardware, and/or firmware components for storing, updating, and providing in real-time user profiles based on up-to-the-second user activity of a user 160 operating a client device 150.

The operation of host system 100 as described with reference to FIG. 1A also applies to host system 100 with reference to FIG. 1B. Specifically, host system 100 includes web applications 110, real-time user profile platform (RTUPP) 120, targeted ads/content service (TACS) 130 coupled to web applications 110 and to RTUPP 120. RTUPP 120 includes a user event service (UES) 122 coupled to web applications 110, a user profile service (UPS) 124 coupled to TACS 130, a profile processor 126 coupled to UES 122, and a universal profile and event store (UPES) 128 coupled to the UES 122, to the UPS 124, and to the profile processor 126. Likewise, host system 100a includes web applications 110a, real-time user profile platform (RTUPP) 120a, targeted ads/content service (TACS) 130a coupled to web applications 110a and to RTUPP 120a. RTUPP 120a includes a user event service (UES) 122a coupled to web applications 110a, a user profile service (UPS) 124a coupled to TACS 130a, a profile processor 126a coupled to UES 122a, and a universal profile and event store (UPES) 128a coupled to the UES 122a, to the UPS 124a, and to the profile processor 126a. Additionally, UPES 128 and UPES 128a are coupled, so that user event data and user profile data stored in UPES 128 may be replicated in UPES 128a and vice versa. Replication may occur in real-time, and serves to achieve various functions. For example, distributed replication in multiple stores ensures data redundancy to prevent loss of data. Distributed replication further allows real-time processing of massive amounts of users, user events, and user profile data across many different web applications 110 and 110a served by different service providers and hosted by different host systems 100 and 100a. In this manner, TACS 130 and 130a may leverage the real-time (e.g., up-to-the-second) user event information and user profile information based on user interactions with web applications 110 and 110a.

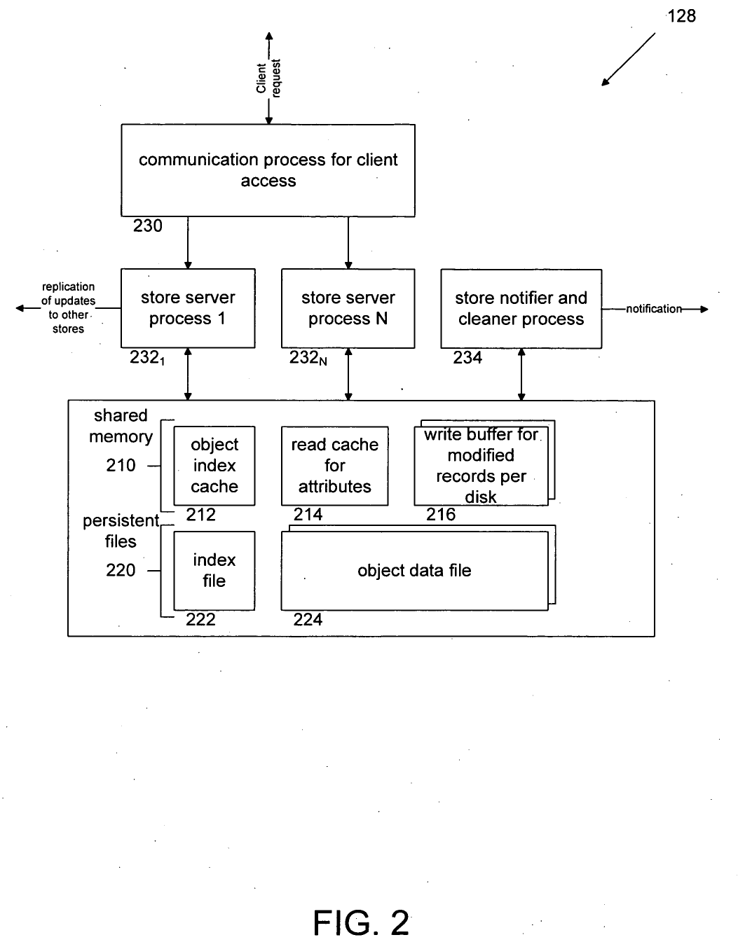

FIG. 2 is a block diagram presenting one embodiment of a universal profile and event store 128. According to FIG. 2, a universal profile and event store (UPES) 128 comprises shared memory 210, persistent files 220, a communication process 230, store server processes 232₁, 232_{N} (hereinafter each identified as store server process 232), and a store notifier and cleaner process (SNCP) 234. According to one embodiment, shared memory 210 may include object index cache 212, read cache 214, and write buffer 216. Persistent files 210 may include index file 222 and object data file 224.

Persistent files 220 store each user's universal profile and user event information. More specifically, object data file 224 stores the users' data, while index file 222 provides the location and/or other metadata of user data. In order to ensure fast response times to applications, the UPES 128 utilizes shared memory 210. The object index cache 212 maintains an index of cached data and additionally caches data from the index file 222 to determine the location of the data faster, i.e., whether on disk or in shared memory. The read cache 214 caches profile attribute data retrieved from the object data file 224. The write buffer 216 stores user event data and modified profile data recently received from a web application 110. Thus, instead of repeatedly and constantly accessing the persistent files 220 for read lookups and write updates, the UPES 128 uses the shared memory 210 including the in-memory read cache 214 and write buffer 216. In one embodiment, object data file 224 is updated from the write buffer 216 only when the write buffer 216 is full. If a user is removed, the UPES 128 need only update the in-memory copy of the index file 222.

Communication process 230 processes communications for client access to the UPES 128. That is, communication process 230 handles communications between the UPES 128 and the UES 122 for the UES 122 to store user events and for the UPES 128 to send notifications to the UES 122. Communication process 230 handles communications between the UPES 128 and the UPS 124 for the UPS 124 to send profile requests to the UPES 128 and for the UPES 128 to send profile information to the UPS. Store server process 232 replicates incoming requests for client access to the UPES 124. That is, the UPES 128 creates multiple instances of store server process 232 in order to address the possibility of data loss. Store server process 232 also replicates updates to other stores (i.e., other instances of UPES 128 hosted by other host systems). Replication occurs in real-time so that the updated user profile data may be available immediately rather than in days. Store notifier and cleaner process (SNCP) 234 handles notification and data cleanup. SNCP 234 periodically applies global data policies, including global expiration policies and notification policies, to data stored in persistent files 220. Also, SNCP 234 may perform notification and data cleanup triggered by storage of a user event, an update of a user's universal profile, or the passage of time or period of inactivity.

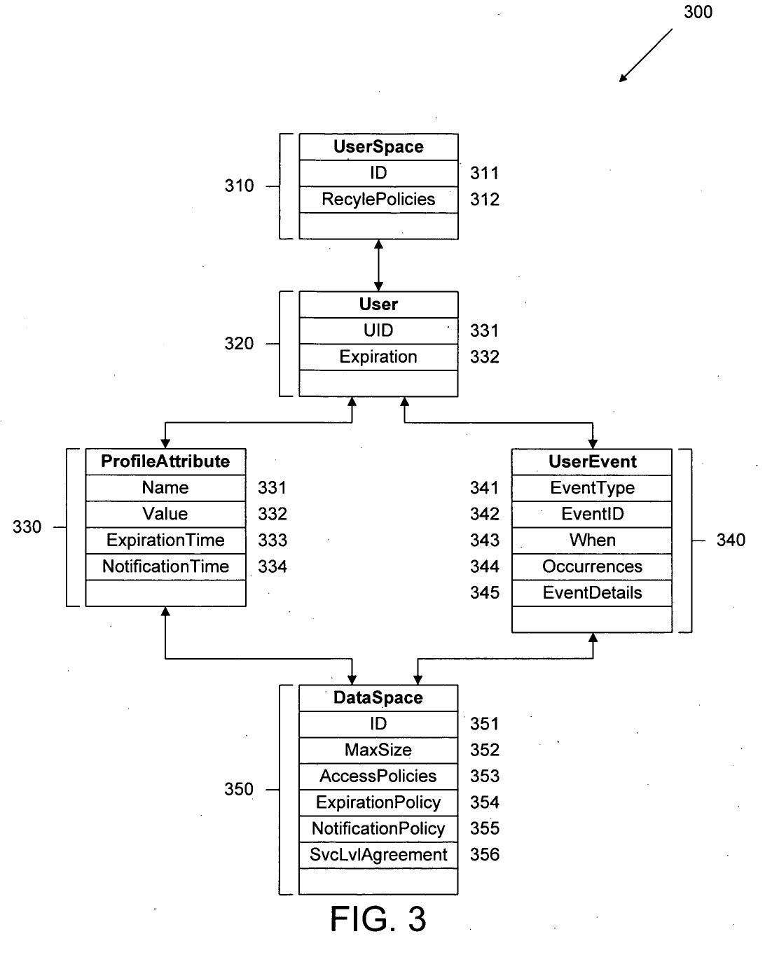

FIG. 3 is a block diagram presenting one embodiment of a data model 300 for objects within the UPES 128. According to FIG. 3, UPES 128 comprises a number of data structures, such as UserSpace table 310, User table 320, ProfileAttribute table 330, UserEvent table 340, and DataSpace table 350. UserSpace table 310 may include data fields ID 311 and RecyclePolicies 312. User table 320 may include data fields UID 321 and Expiration 322. ProfileAttribute table 330 may include data fields Name 331, Value 332, ExpirationTime 333, and NotificationTime 334. UserEvent table 340 may include data fields EventType 341, EventID 342, When 343, and Occurences 344. DataSpace table 350 may include data fields ID 351, MaxSize 352, AccessPolicies 353, and ExpirationPolicy 354. It should be noted that the data structures comprising the UPES 128, while described here as tables, may also be implemented as entries within tables. For example, UserSpace table 310 may include multiple table entries, with each table entry corresponding to one User table 320. Similarly, a user table 320 may include multiple table entries, where each table entry is one of a ProfileAttribute table 330 or a UserEvent table 340. Other data structures may alternatively or additionally be used.

UserSpace table 310 is linked to User table 320. A UserSpace table 310 may be linked to multiple different instances of User table 320. Similarly, a given User table 320 may be linked to multiple different instances of UserSpace table 310. User table 320 is linked to ProfileAttribute table 330 and UserEvent table 340. User table 320 may be linked to multiple different instances each of ProfileAttribute table 330 and UserEvent table 340. ProfileAttribute table 330 and UserEvent table 340 are also linked to DataSpace table 350. DataSpace table 350 may be linked to multiple different instances each of ProfileAttribute table 330 and UserEvent table 340. Similarly, a given ProfileAttribute table 330 may be linked to multiple different instances of DataSpace table 350. Likewise, a given UserEvent table 340 may be linked to multiple different instances of DataSpace table 350.

UserSpace table 310 corresponds to a user space, which is a collection of users sharing at least one characteristic. Some examples of shared characteristics include registration status or class of membership for a particular service, or status as a user who has performed a particular class of user event. Accordingly, UserSpace table 310 may be linked to multiple different instances of User table 320. Each user space has a specific set of policies for managing data associated with users in that user space. These policies apply globally to all users within the particular user space. UserSpace table 310 may include data fields ID 311 and RecyclePolicies 312. ID 311 identifies a particular user space and RecyclePolicies 312 identify a data recycling policy associated with the user space. For example, UPES 128 may have one user space for registered users of Yahoo! and another user space for Yahoo! visitors. The user space for visitors may have a data recycling policy that all data should be removed from the UPES 128 if a visitor does not interact with Yahoo! for a given time period, such as 3 months. The user space for registered users may have a data recycling policy that all data should be removed from the UPES 128 if the registered user does not interact with Yahoo! for a different given time period, such as 24 months.

Each instance of a User table 320 corresponds to a specific user. A user may belong to one or more different user spaces. Accordingly, User table 320 may be linked to multiple different instances of UserSpace table 310. User table 320 may include data fields UID 321 and Expiration 322. UID 321 identifies a given user and may be, for example, a user ID, login name, or account name. Expiration 322 is associated with the user, and may include a date when the User table 320 should be deleted. This date may be updated based on user events, or may be changed by individual user preferences or by global data policies.

ProfileAttribute table 330 corresponds to a specific user and a specific attribute of that user's universal user profile. A user's universal profile may have many different data fields corresponding to different attributes. Accordingly, User table 310 may be linked to multiple different instances of ProfileAttribute table 330. ProfileAttribute table 330 may include data fields Name 331, Value 332, ExpirationTime 333, and NotificationTime 334. Name 331 identifies an attribute corresponding to a given user. Value 332 identifies the value of the corresponding attribute Name 331. ExpirationTime 333 indicates a period of time after which the data stored in ProfileAttribute table 330 expires and should be deleted from the UPES 128. NotificationTime 334 indicates a period of time after which a notification should be sent to take action (such as a notification to the UES 122 and forwarded to the marketing tool 140 to send marketing information to a user).

UserEvent table 330 corresponds to a specific user and a specific user event. A user's universal profile may have many different data fields corresponding to different user events. Accordingly, User table 320 may be linked to multiple different instances of UserEvent table 340. UserEvent table 340 may include data fields EventType 341, EventID 342, When 343, Occurrences 344, and EventDetails 345. EventType 341 identifies a type of user event corresponding to a particular interaction with a web application, such as a search query. EventID 342 identifies a particular instance of a user event. When 343 identifies when a given user event occurred. Occurrences 344 identifies the number of times a given user event has occurred. EventDetails 345 includes specific details about a given user event. For example, if the type of user event identified by EventType 341 were a search query, then EventDetails 345 may include specific keywords forming the basis of the query.

DataSpace table 350 corresponds to a data space, which is a collection of pieces of data, such as profile attributes and user events, sharing at least one characteristic. Accordingly, DataSpace table 350 may be linked to multiple different instances each of ProfileAttribute table 330 and UserEvent table 340. Each data space has a specific set of policies for managing data associated with that data space. These policies apply globally to all data within the particular data space. DataSpace table 350 may include data fields ID 351, MaxSize 352, AccessPolicies 353, ExpirationPolicy 354, NotificationPolicy 355, and SvcLvlAgreement 356. ID 351 identifies a particular data space. MaxSize 352 identifies the maximum size for the data space. AccessPolicies 353 identifies access policies for data within the data space. In one embodiment, the AccessPolicies 353 may specify which web applications 110 of host system 100 may access the data in the data space. In this situation, a common service provider serves all of the web applications 110 on host system 100. In other embodiments, the AccessPolicies 353 may grant access to data in the data space to web applications not part of host system 100. In this situation, different service providers serve various web applications. ExpirationPolicy 354 identifies an expiration policy for data within the data space. For example, a data space called “Search History” may have a maximum size of 500, meaning that up to 500 searches are saved in a search history. An expiration policy may require that data expire after 2 months, for example, unless the user explicitly requested otherwise. NotificationPolicy 355 identifies a notification policy for data within the data space. SvcLvlAgreement 356 identifies a service level agreement applicable to the data space. Different data spaces may be associated with different levels of service (e.g., in terms of response time) based on the service level agreement.

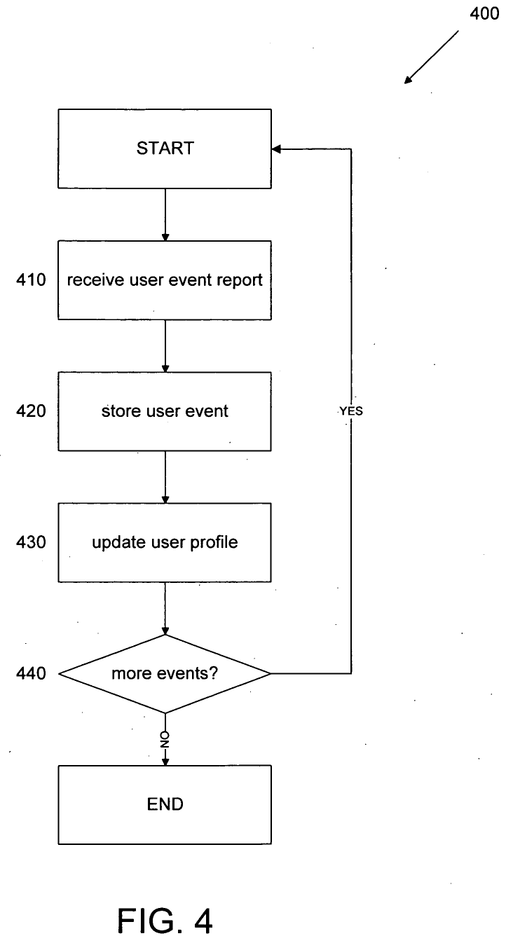

FIG. 4 is a flow diagram presenting one embodiment of a method 400 for storing user events and updating a user profile based on user events. According to FIG. 4, at step 410, a user event service (UES) 122 of a real-time user profile platform (RTUPP) 120 receives a report of a user event from a web application 110 with which a user is interacting. At step 420, the UES 122 stores user event information in the user's universal profile in a universal profile and event store (UPES) 128 of the RTUPP 120. At step 430, a profile processor 126 of the RTUPP 128 processes the data to generate metadata associated with the user event and updates the user's universal profile. At step 440, the RTUPP 120 performs a check to determine whether additional reported user events exist. If so, the method returns to step 410. If not, method 400 then ends.

For example, a user may interact with a web application 110 such as a dating and personals service. The user may upload a photo to the dating and personals service, and this interaction may be recorded as a user event. The web application 110 for the dating and personals service reports the user event to the UES 122, which stores the user event in the UPES 128. The profile processor 126 processes the data to generate metadata associated with the user event and updates the user's universal profile stored in the UPES 128. The user's universal profile may be updated so that a profile attribute, for example, called “PhotoUploaded” is set to the value “True.”

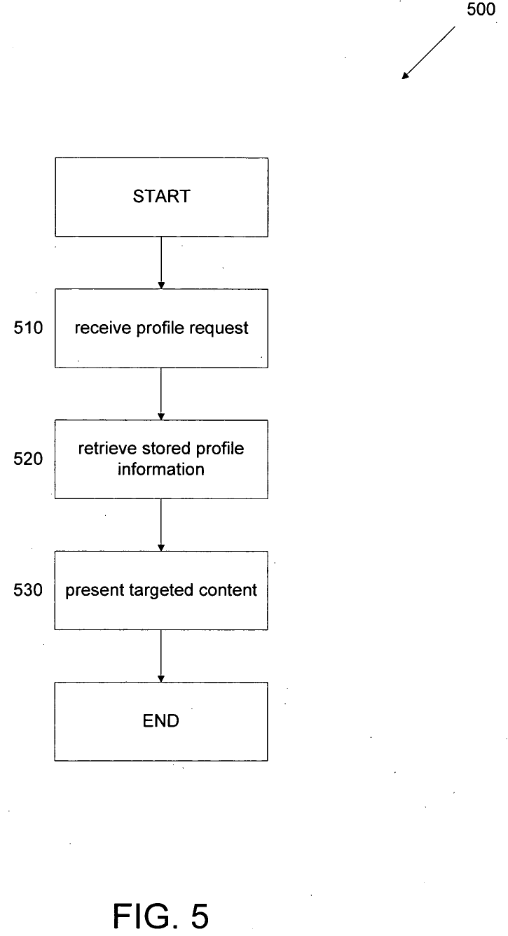

FIG. 5 is a flow diagram presenting one embodiment of a method 500 for retrieving a user profile and presenting targeted content based on the user profile. According to FIG. 5, at step 510, a user profile service (UPS) 124 of a real-time user profile platform (RTUPP) 120 receives a profile request from a web application 110 with which a user is interacting. At step 520 the UPS 124 retrieves a user's universal profile from a universal profile and event store (UPES) 128 of the RTUPP 120 and sends profile information representing all or part of the user's universal profile to the web application 110. At step 530, a host system 100 presents the user with targeted content. The UPS 124 sends profile information representing all or part of the user's universal profile to a targeted ads/content service (TACS) of the host system 100. Based on the profile information, the TACS 130 presents targeted content (e.g., ads) to the user via a web application 110 hosted by the host system 100. The method 500 then ends.

For example, a user may interact with a web application 110 such as music service. The web application 110 for the music service sends a request for the user's profile to the UPS 124, which retrieves the user's universal profile from the UPES 128 and sends it to the web application 110. The UPS 124 presents profile information to the TACS 130. This profile information may include information that the user's favorite music genre is classic rock and may also include information that the user recently performed searches for a sport utility vehicle (SUV) using a car shopping service. The TACS 130 presents targeted content based on the profile information. The TACS 130, through web application 110 for the music service, may present the user with, for example, featured content in the genre of classic rock. The TACS 130, through web application 110 for the music service, may also present the user with targeted ads related to SUV dealerships, auto financing companies, and auto insurance companies. If a new user event occurs, e.g., from the same or another web application 110, the TACS 130 may be armed with the current information. In this manner, targeted content is based on up-to-the-second user interest information gleaned from up-to-the-second user interactions with various web applications 110.

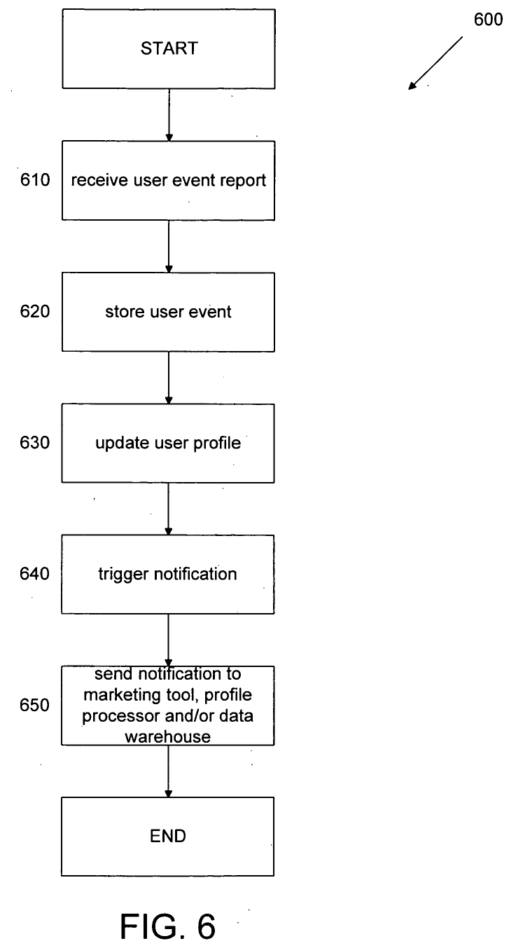

FIG. 6 is a flow diagram presenting a method 600 for sending a notification based on a user-triggered event. According to FIG. 6, at step 610 a user event service (UES) 122 of a real-time user profile platform (RTUPP) 120 receives a report of a user event from a web application 110 with which a user is interacting. At step 620, the UES 122 stores user event information in a universal profile and event store (UPES) 128 of the RTUPP 120. At step 630, the RTUPP updates the user's universal profile. In one embodiment, a profile processor 126 of the RTUPP 120 processes the data to generate metadata associated with the user event and updates the user's universal profile based on the user event. Alternatively or additionally, the UPES 128 of the RTUPP 120 may perform a process to update the user's universal profile based on the recently stored user event. At step 640, the RTUPP 120 triggers a notification. In one embodiment, a profile processor 126 triggers the notification based on the updating of the user's universal profile in UPES 128, so that the UPES 128 sends the UES 122 a notification. Alternatively or additionally, a UPES 128 process such as a store notifier and cleaner process (SNCP) 234 applies a notification policy (using a NotificationTime 334) based on a ProfileAttribute 330 updated in the user's universal profile and sends a notification to the UES 122. In this way, the UPES 128 is configured to trigger a notification to be sent to consuming applications and services based on an occurrence of a specific event, an updating of the user profile, a notification policy, or the passage of a set period of time. Examples of consuming applications and services include marketing tool 140 for sending a user marketing information, profile processor 126 for updating a user profile, and data warehouse 170 for updating or modifying stored data. At step 650, the host system 100 sends a notification based on the triggered notification. The UES 122 sends the notification and identifying information, such as part of the user's universal profile, to a marketing tool 140 of the host system 100. The marketing tool 140 then sends the marketing information to the user 160, and method 600 then ends. Alternatively or additionally, the UES may send the notification to the profile processor 126 or to the data warehouse 170.

For example, a user may interact with a web application 100 such as a dating and personals service. The user may upload a photo to the dating and personals service, and this interaction may be recorded as a user event. The web application for the dating and personals service reports the user event to the UES 122, which stores user event information in the UPES 128. The profile processor 126 processes the event information to generate metadata associated with the user event from the user event information and updates the user's universal profile. Alternatively or additionally, the UPES 128 performs a process to update the user's universal profile based on the recently stored user event. The user's universal profile may be updated so that a profile attribute, for example, called “PhotoUploaded” is set to the value “True.” By updating the user's profile, the profile processor 126 triggers a notification to be sent from the UPES 128. Alternatively or additionally, a UPES 128 process such as a store notifier and cleaner process (SNCP) 234 applies a notification policy based on the profile attribute “PhotoUploaded” being updated in the user's universal profile. The UES 122 receives the notification from the UPES 128, and sends the notification along with user identifying information, such as part of the user's universal profile, to the marketing tool 140. The marketing tool 140 sends the user marketing information, such as an email containing an offer for an upgraded membership. As another example, the UPES 128 may recognize that a photo has not been uploaded and may trigger a notification to inform the user that his registration may be inactivated unless a photo is added. Alternatively or additionally, the UES 122 may send the notification to the profile processor 126 to update the user's profile or the UES 122 may send the notification to the data warehouse 170 to update or modify the data stored or archived therein.

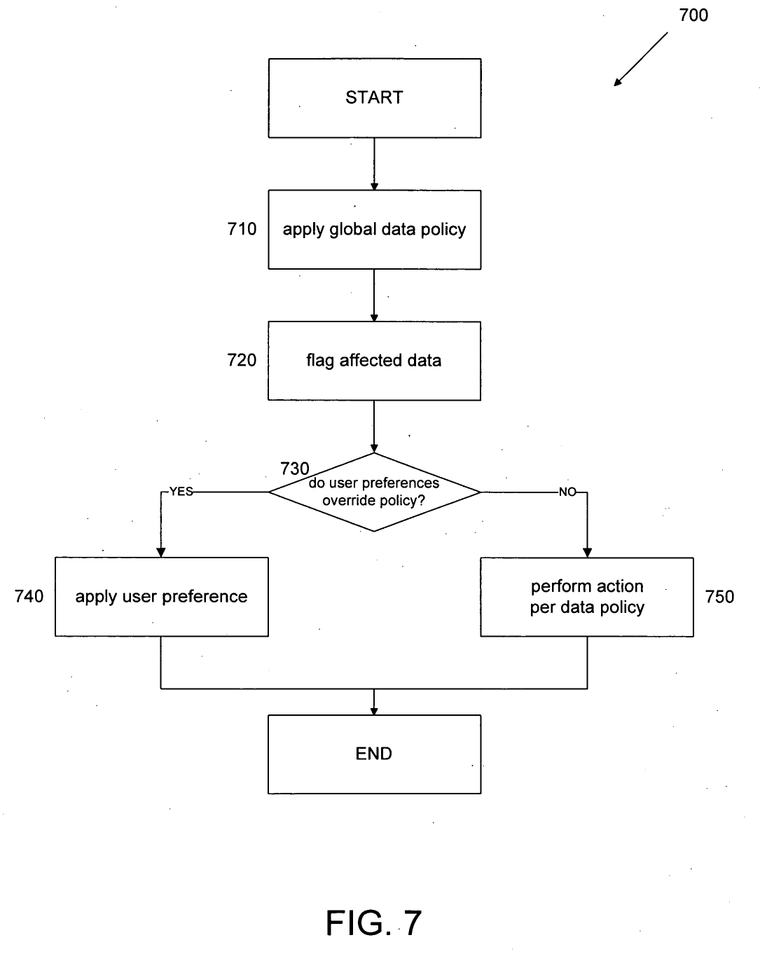

FIG. 7 is a flow diagram presenting one embodiment of a method 700 for periodic data cleanup and user notification by a profile and events store. According to FIG. 7, at step 710, a universal profile and event store (UPES) 128 applies a global data policy to stored data. The global data policy may be, for example, a recycle policy for a particular user space or an expiration policy for a particular data space. The global data policy may also relate to a notification time for a profile attribute within either a user space or a data space. A store notifier and cleaner process (SNCP) 234 of the UPES 128 applies the global data policy to stored data in the affected user space or data space. At step 720, the UPES 128 flags affected data. Affected data may be a data structure such as a profile attribute or a user event, or may be raw data such as a value stored in a data field of a data structure. Affected data may even be a data structure including a user's entire universal profile. The SNCP 234 of the UPES 128 flags affected data for possible deletion or other action. At step 730, the UPES 128 performs a check to determine whether an individual user's preferences override the global data policy. If so, the UPES 128 applies the user preference and does not take the action on the data at step 740. Otherwise, the UPES 128 applies the global data policy and takes the action, such as deletion and/or notification at step 750. Method 700 then ends.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

We claim:

1. A method comprising:
receiving a real-time report of a user event corresponding to an interaction with a first web application by a user;
storing representative data of the user event in a store to update a user profile;
receiving a request for the user profile from a second web application; and
retrieving in real-time at least a portion of the user profile from the store.

2. A method according to claim 1, wherein the first web application and the second web application are served by a common service provider.

3. A method according to claim 1, wherein the first web application and the second web application are served by different service providers.

4. A method according to claim 1, further comprising:
updating the user profile based on a reported user event.

5. A method according to claim 4, wherein the updating the user profile occurs dynamically.

6. A method according to claim 4, wherein updating the user profile utilizes a shared write, cache accessible by both the first web application and the second web application and wherein retrieving in real-time at least a portion of the user profile from the store utilizes a shared read cache accessible by both the first web application and the second web application, thereby reducing an amount of disk access.

7. A method according to claim 1, further comprising:
providing the at least a portion of the user profile to the second web application.

8. A method according to claim 1, further comprising:
providing the at least a portion of the user profile to the second web application;
generating targeted content based on the at least a portion of the user profile; and
presenting targeted content to the user via the second web application.

9. A method according to claim 1, further comprising:
determining that a triggering event has occurred; and
performing an action including at least one of deleting at least a portion of the user profile, deleting a stored user event, and sending a notification in real-time with respect to the triggering event.

10. A method according to claim 9, wherein the triggering event includes an occurrence of a specific user event, an updating of a user profile, a data policy, or passage of a set period of time.

11. A method according to claim 9, wherein sending a notification includes sending a notification to a profile processor to update a user profile, sending a notification to a marketing tool to send marketing information to a user, or sending a notification to a data warehouse to update or modify data stored therein.

12. A method comprising:
receiving a report of a user event corresponding to an interaction with a first web application by a user;
storing representative data of the user event in a store to update a user profile;
receiving a request for the user profile from a targeted content service;
retrieving in real-time at least a portion of the user profile from the store; and
providing targeted content to the user via a second web application.

13. A method according to claim 12, wherein the first web application and the second web application are served by a common service provider.

14. A method according to claim 12, wherein the first web application and the second web application are served by different service providers.

15. A method according to claim 12, wherein the first web application and the targeted content service are served by a common service provider.

16. A method according to claim 12, wherein the first web application and the targeted content service are served by different service providers.

17. A method according to claim 12, further comprising:
updating the user profile based on the stored representative data of the user event.

18. A method according to claim 17, wherein the updating the user profile occurs in real-time with respect to the receiving of the report of the user event.

19. A method according to claim 17, wherein updating the user profile includes replicating the user profile in real-time.

20. A method according to claim 19, wherein replicating the user profile in real-time utilizes a shared write cache accessible by web applications served by different service providers and a shared read cache accessible by targeted content services served by different providers, thereby reducing an amount of disk access.

21. A method according to claim 12, further comprising:
providing the at least a portion of the user profile to the second web application; and
presenting a customized experience to the user via the second web application based on the at least portion of the user profile.

22. A method according to claim 12, further comprising:
determining that a triggering event has occurred; and
performing an action including at least one of deleting at least a portion of the user profile, deleting a stored user event, and sending a notification in real-time with respect to the triggering event.

23. A method according to claim 22, wherein the triggering event includes an occurrence of a specific user event, an updating of a user profile, a data policy, or passage of a set period of time.

24. A method according to claim 22, wherein sending a notification includes sending a notification to a profile processor to update a user profile, sending a notification to a marketing tool to send marketing information to a user, or sending a notification to a data warehouse to update or modify data stored therein.

25. A system comprising:
a plurality of web applications, each operative to interact with a user; and
a universal profile and event store operative to store user profiles and user events representing interactions with the web applications by the user.

26. A system according to claim 25, wherein the web applications are configured to present the user with a customized experience based on at least a portion of the user's profile.

27. A system according to claim 25, wherein universal profile and event store is configured to conduct data cleanup of the user profiles and user events based on expiration policies.

28. A system according to claim 25, wherein the universal profile and event store is configured to send a notification based on an occurrence of a specific user event, an updating of the user profile, a notification policy, or passage of a set period of time.

29. A system according to claim 25, wherein:
a user profile comprises profile attribute data; and
the universal profile and event store is organized into user spaces and data spaces;
wherein a user space is a collection of users that share at least one characteristic and a data space is a collection of profile attribute data and user event data that share at least one characteristic.

30. A system according to claim 29, wherein each user space has an expiration policy and each data space has an expiration policy and a notification policy.

31. A system according to claim 25, wherein the universal profile and event store is organized into a data model that comprises:
a data structure for a profile attribute;
a data structure for a user event;
a data structure for a user comprising links to profile attributes and user events associated with the user;
a data structure for a user space comprising a first data policy and links to users sharing at least one characteristic; and
a data structure for a data space comprising a second data policy and links to profile attributes and user events sharing at least one characteristic;
wherein the universal profile and event store is configured to conduct data cleanup or notification to a user space by applying the first data policy and to a data space by applying the second data policy.

32. A system according to claim 25, wherein the universal profile and event store comprises:
persistent files stored on a disk including an object data file storing a user's profile data and event data and index file that provides the location of the user's data;
shared memory including a read cache for caching retrieved profile data and a write cache for reported user event data and modified profile data and an object index cache that provides the location of the data in the shared memory as well as on the disk;
wherein the universal profile and event store is configured to utilize the shared memory in order to decrease an amount of disk access.

33. A system according to claim 32, wherein the universal profile and event store further comprises:
a plurality of store server processes; and
a store notifier and cleaner process;
wherein the store server processes are configured to replicate updates to user profile data to other universal profile and event stores and wherein the store notifier and cleaner process is configured to periodically conduct data cleanup and notification procedures.

34. A system according to claim 25, further comprising:
a targeted content service operative to present the user with targeted content, wherein the targeted content is based on at least a portion of the user's profile.

35. A system according to claim 25, further comprising:
a marketing tool operative to present the user with marketing information based on a triggered notification by the universal profile and event store.

36. A system according to claim 25, further comprising a profile processor operative to update a user profile based on a triggered notification by the universal profile and event store.

37. A system comprising:
means for receiving a report of a user event corresponding to an interaction with a first web application;
means for storing representing data of the user event to update a user profile;
means for receiving a request for a user profile from a second web application; and
means for retrieving in real-time at least a portion of the user profile.

38. A system comprising:
means for receiving a report of a user event corresponding to an interaction with a first web application;
means for storing representing data of the user event to update a user profile;
means for receiving a request for a user profile from a targeted content service;
means for retrieving in real-time at least a portion of the user profile; and
means for providing targeted content via a second web application based on the at least a portion of the user profile.
